(19) United States
(12) Patent Application Publication
(10) Pub. No.: US 2004/0153352 A1
(43) Pub. Date: Aug. 5, 2004

(54) Vendor referral system

(76) Inventors: James Berns, San Diego, CA (US); Gary Hoke, San Diego, CA (US)

Correspondence Address: FISH & RICHARDSON, PC, 12390 EL CAMINO REAL, SAN DIEGO, CA, 92130-2081, US

(21) Appl. No.: 10/361,487

(22) Filed: Feb. 5, 2003

(51) Int. Cl. G06F 17/60

(52) U.S. Cl. 705/8

(57) ABSTRACT

A method includes storing a set of vendor referral information in a vendor referral database, wherein the set of vendor referral information corresponds to a sphere of influence of a host entity, and wherein the host entity controls the storing of the vendor referral information stored in the vendor referral database, receiving a vendor referral inquiry on a computer network, and sending at least one vendor referral from the vendor referral database in response to the received vendor referral inquiry.

### TECHNICAL FIELD

This description relates to presenting and managing vendor referral information.

### BACKGROUND

The World Wide Web refers to a portion of the Internet composed of many server computers that make media documents available for downloading by individuals having a computer with Internet access. The documents typically are created in Hypertext Markup Language (HTML), Extended Markup Language (XML), and/or Cold Fusion Markup Language (CFML). The documents may be displayed on a user device having a graphical user interface (GUI). HTML (or XML, or CFML) documents may include embedded hyperlinks (“links” or “hyperlinks”) in an active area on the display that reference resources at other locations (e.g., a folder, or other HTML/XML/CFML documents, etc.) A document controlled by a particular individual or business is often referred to as a “website”. Each website document may include a variety of content (e.g., text and graphics), which is controllable by the individual or business.

The World Wide Web has experienced tremendous growth and now has millions and millions of websites and related documents available for viewing on a user device. The vast number of websites available has made it difficult for a user to personally know or determine the reliability of information presented on those websites. Some conventional websites present vendor referral information in an indirect manner, e.g., a user is first required to fill out a request form which must be processed by another individual before the user receives any vendor referral information. The request form is typically forwarded to an individual (e.g., an employee of the website owner) who either forwards the request to a vendor(s), or provides one or more vendor referrals to the requesting user by phone or e-mail, for example. Many conventional websites involve monetary compensation be paid from a vendor to a website owner in order to be included on the list of vendors who may be referred (e.g., and/or paying a transaction fee for each vendor referral from the website owner.)

### DESCRIPTION OF THE DRAWINGS

FIG. 1 is a block diagram of a server system.

FIG. 2 is a flowchart of a process for storing and providing access to vendor referral information.

FIG. 3 is a web-page presenting vendor referral information.

FIG. 4 is a block diagram of a server system.

FIG. 5 is a block diagram of computer hardware on which the process corresponding to FIG. 2 may be implemented.

### DESCRIPTION

As used herein, the term “computer system” refers to a physical machine having one or more processing elements and one or more storage elements in communication with the one or more of the processing elements. Each of the various user devices and computers described herein include an operating system. The operating system is software that controls the computer system's operation and the allocation of resources. The term “process” or “program” refers to software, for example an application program that may be executed on a computer system. The application program is the set of executable instructions that performs a task desired by the user, using computer resources made available through the operating system.

The description contained herein presents embodiments in which information is passed between a user and a user device, e.g., a computer system, using conventional means such as a keyboard, a mouse, a physical transducer (e.g., a microphone), etc. However, this is not meant to preclude the use of other mechanisms for passage of information between a user and a computer system.

Certain terms used throughout this specification and claims, although originating in the context of conventional visual displays, are intended to include corresponding functions in the context of other types of information delivery. For example, “window” refers to any set of information available for presentation to a user. A window can include information displayed in a portion of a visual computer display. However, a window can also encompass the entire visual computer display.

A typical display window on a user device may include one or more “active” regions. The active regions are associated with instructions to be executed upon the occurrence of an event within the active region. For example, instructions associated with an active region may cause a jump to a specified location (e.g., a hyperlink to a website) upon the occurrence of a mouse-click within the active region. Other events can also cause the execution of instructions. In particular, a detected movement of a mouse and/or an entry of a mouse pointer into an active region (in either case, with or without a click of a mouse button) are also events that may be used to trigger the execution of instructions associated with that region.

The display window on a user device may include a “desktop”, e.g., desktop refers to a graphical work surface analogous to a surface of a desk. Similarly, additional windows may overlay the desktop in the graphical user interface, the additional windows are analogous to papers or files laying on top of a desk. In some cases the desktop window, or an additional window(s), may include icon(s) that represent a program, a file, a resource, etc., available to the user. As such, the desktop acts as a launching point for running application programs, opening documents or files, displaying menus, and/or initiating operating system services, and the like.

Internet/intranet user devices and server computers communicate through software protocols, such as File Transfer Protocol (FTP), Simple Mail Transfer Protocol (SMTP), Hypertext Transfer Protocol (HTTP), and the like. HTTP is a widely used protocol and is used for accessing the “World Wide Web” or virtual private networks (VPN).

The system and associated process described herein may be used to store and serve a database of vendor referral information over a computer network, such as the Internet and/or an intranet. In an implementation, the system is controlled by a host (e.g., an individual who may be a business professional, an employee associated with a business entity, a group of individuals associated with a business entity, a business or other entity, or the like.) The host controls and manages the system to ensure that the vendor referral information available and/or displayed on a host website is reliable (e.g., considered high quality and/or of known integrity) and therefore useful and reliable for a user of the host website. In an embodiment, the host of the website system is a business professional, e.g., a real estate professional, an insurance agent, a financial planner, a group of businesses, a stock broker, or the like. In another embodiment, the host is an entity that relies heavily on referrals and would have a large sphere of influence (such as a real estate professional). The website also may include information and or hyperlinks that are related to the realty business. For example, the host website may include one or more real estate listings, and/or a hyperlink to another website of the host dealing directly in real estate.

In operation of the system, an initial list of vendor referral information is entered into a database (e.g., the vendor referral database) on a server computer coupled to the Internet and/or an intranet. Alternatively, the vendor referral information is stored on some other repository of information. The initial list of vendor referral information may include information representing vendors personally known to the host and/or reliably referred to the host. The vendor referral information represents and includes, for example, a vendor's name, address, phone number, e-mail address, or the like. The initial list of vendors may be referred to as originating from the host's “sphere of influence” (SOI). Sphere of influence refers to the host's current clients, former clients, friends, neighbors, relatives, or other individuals that the host has dealt with and trusts. Thus, there is typically an element of trust associated with the host's SOI. However, the user also has an element of trust associated with the vendor referral information, because in many instances the user will have personal knowledge of the host (e.g., knows the host as opposed to just randomly found the host's website) and the vendor referral information is deemed reliable by the host. Accordingly, vendor referral information originating from the host's SOI differs from the conventional practice of selecting vendor referral information without any prior knowledge (such as selecting names from a phonebook or a source in which no reliability is associated but rather just charges vendors to be listed with the source) or from receiving vendor referral information from an anonymous entity from which the user has no personal relationship.

Vendor referral information is reliably referred to a host, for example, when it is referred from an individual or entity within the host's SOI. When an individual or entity within the host's SOI considers a new vendor trustworthy, the host may presume the new vendor as trustworthy, unless demonstrated to be otherwise.

In one embodiment, the reliability level of a vendor referral is indicated and/or graphically illustrated, for example using one or more icons associated with a vendor referral. One such icon could indicate that a vendor referral was referred directly by the host and thus identified to be of “high” reliability. Another such icon could indicate the vendor referral originated from a member of the host's SOI and thus identified to be of “high” reliability. Another such icon could indicate that the vendor referral is a member of the host's SOI and thus identified to be of “high” reliability. A yet another such icon could indicate that vendor referral was an unsolicited vendor referral from an individual known to the host, for example, a vendor referral originating from someone known to the host but not a member of the host's SOI. Such a vendor referral could be identified to be of “medium” reliability. A further icon could indicate the vendor referral originated from another vendor already listed within the host's vendor referral database and thus identified to be of “medium” reliability. If the system includes anonymous or unsolicited referrals, another icon could be used to indicate that a vendor referral was an unsolicited referral, from an individual unknown to the host, but the vendor referral has provided their identity (an unsolicited, attributed referral). Such a vendor referral could be identified to be of “extremely low” reliability. Moreover, if the system includes anonymous or unsolicited referrals, another icon could be used to indicate that a vendor referral was anonymous and/or an unsolicited referral from an individual unknown to the host. Such a vendor referral could be identified to be of “extremely low” reliability. According to this embodiment, any, all or none of the above icons may be used.

In an embodiment, any vendor may be removed from the vendor referral database and/or the host's SOI for any reason, at the host's discretion (such as when a complaint about the vendor is received or the vendor is deemed unreliable); it is a privilege, not a right, to be included in the vendor referral database and/or host's SOI. Thus, a vendor cannot pay a fee or otherwise demand to be included in the vendor referral database and/or host's SOI.

In addition, the system may further include testimonials relating to the reliability of various vendor referrals. These testimonials can be attributed or be anonymous.

In an implementation, the process described herein is a dynamic process, e.g., following storage of the initial set of vendor referral information in the vendor referral database, supplementary vendor referral information may be added to the vendor referral database. For example, a vendor from the SOI list may refer another vendor to the host website, or a user may send information for a supplementary vendor by interacting with the website. Therefore, in some configurations, the process allows and promotes an ongoing, dynamic system of vendor referral(s). Further, the system may allow a host to expand the host's SOI, e.g., by adding users (clients) and vendor(s) to the host SOI. Therefore, the system may allow the host to generate additional business, and business contacts, for itself through the system of providing relatively reliable (e.g., higher quality and trusted) vendor referral information through the host's website. In some cases a vendor may become a client of the host, or vice versa, a user may be become a vendor, each included in a host's SOI. The growth of a host's SOI may increase the amount of business performed by the host.

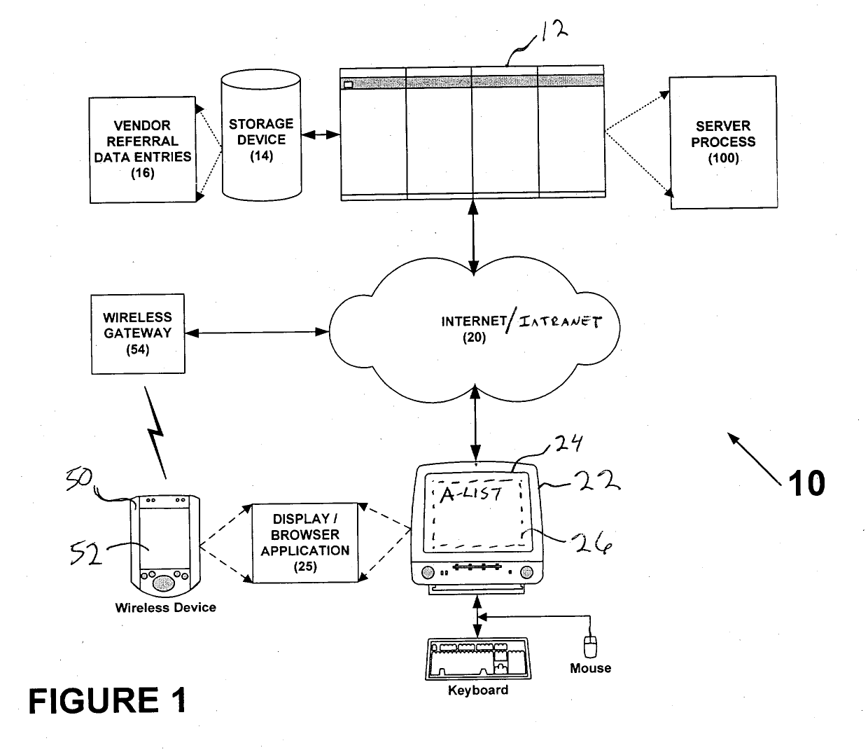

FIG. 1 shows a system 10 that includes a server computer 12 coupled to a storage device 14, and also coupled to a wide area network, e.g., Internet/intranet 20. System 10 may be used to serve a host website document 26 that may be displayed on a display area 24 or 51 by a display application 25 executable on a user device 22 or 50, respectively. The website document 26 may include a representation of one or more vendor referral icons, and/or an active area (e.g., a hyperlink) that may be used to access vendor referral information 16 stored on storage device 14. Storage device 14 may be a vendor referral database. Display application 25 may be a browser application, for example.

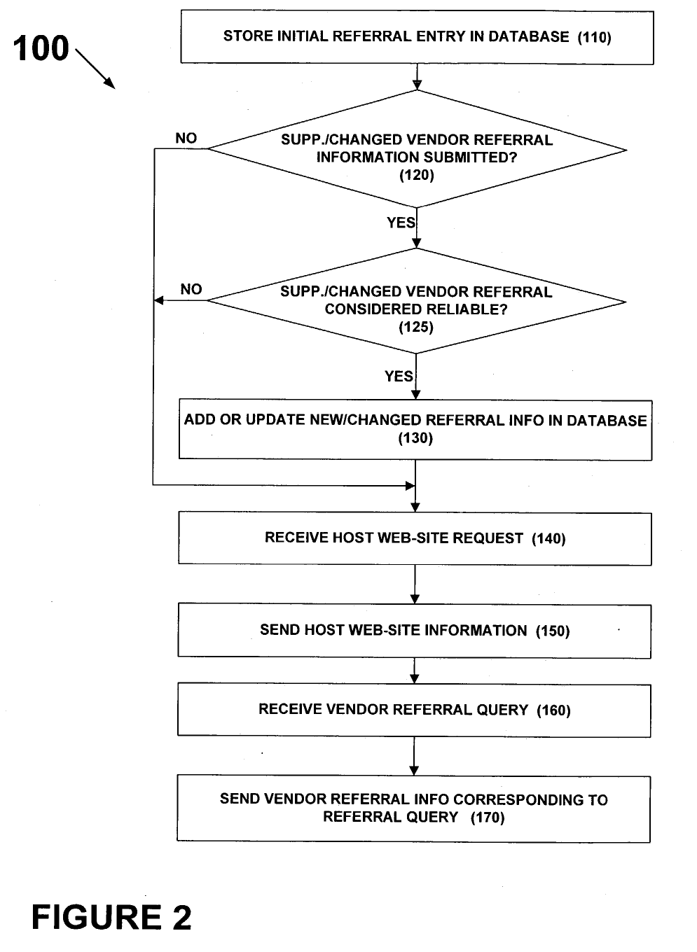

FIG. 2 shows a process 100 that may be performed on system 10 that allows a host to store vendor referral information 16 in a database on server computer 12, and that allows a user to access the vendor referral information 16. In an implementation, process 100 includes storing (110) an initial vendor referral information item in a database and determining (120) whether a supplemental vendor referral or changed (“supp./changed”) referral has been submitted by a user or by an existing vendor in the database. If it is determined that a supplemental vendor referral or changed vendor referral has been submitted, process 100 includes determining (125) whether the supp./changed vendor referral is considered “reliable”. In this example, “reliable” refers to vendor referral information determined reliable by the host of the website to be trustworthy, e.g., meeting or exceeding a threshold of reliability that is configurable by the host of the website. The threshold of reliability may be set by the host entity. For example, the factors looked at in determining reliability, as well as the threshold of reliability may include determining that a supp./changed referral is from a vendor included in the initial list of vendor referrals in the database. Determining (125) may include a verification of vendor credentials and/or standing with an agency, such as the Better Business Bureau™, and/or a governmental licensing board. Still referring to FIG. 2, if the supp./changed vendor referral information is considered reliable, the process 100 adds or updates (130) the database with the supp./changed vendor referral information. Following adding or updating (130) process 100 may include receiving (140) a website page request at the server computer and send (150) the website information corresponding to the host website. In this example, the website information includes information related to one or more referrals stored in the database, and/or an active area that may be activated to cause a further display of vendor referral information. Following sending (150), the process 100 may receive (160) a vendor referral query from a user device and, in response, send (170) vendor referral information from the database corresponding to the vendor referral query. The vendor referral query may be caused by selection of an active area on a display screen of a user device, such as a user device 22 or 50 as shown in FIG. 1.

Providing vendor referral information as described herein provides a level of assurance to a user of system 10 that the supplied vendor referral(s) are of presumed high quality and integrity, especially as compared to vendor(s) randomly selected from a phone book, or a conventional website. Moreover, the user may user may obtain vendor referral information directly and interactively (e.g., without requiring a user to complete and submit a request for vendor information, which must be processed before the vendor referral information is sent).

In various configurations, vendor referral information may be considered to be at differing levels of reliability, for example, a vendor referral from a vendor included in the SOI of a host may be considered more reliable than an “anonymous” referral (e.g., a referral originating from someone other than an a vendor included in the SOI). In an implementation, no supp./changed vendor referral information is added to the database before the host determines the reliability of the supp./changed vendor referral information.

In one embodiment, the host does not independently check the reliability of the vendor referral information (apart from being referred from a reliable source). In still another embodiment, the host does not independently check the reliability of the vendor referral information, but the host provides tools to allow the user to independently check the reliability of a referral, such as with links to other websites like the Better Business Bureau™.

Vendor referral information may be added to the database without charge or obligation to the vendor, or with only a nominal charge or obligation to the vendor. In that case, a user of the host website may be assured that a vendor referral is made on an independent basis and not on the basis of any compensation given from the vendor to host. Alternatively, or in addition, the host may request a vendor to pay a one-time “set-up fee” (e.g., to pay for the inclusion of the vendors logo in a format that is consistent and appealing to the host website), and/or an annual maintenance fee in order to cover the cost of operating the website. In some implementations, the host also may offer to create logos for vendors in order to highlight the vendor's logo on a website page, and/or allow vendors to purchase banner advertising on the host website. The host may charge for services or the host may provide services at no charge as an incentive to the vendor to provide additional supp./changed vendor referral information, and/or other referral information. The host may also provide free advertising and/or services to the vendor either “in-trade” or as a reward for service(s) provided to another member in the host's SOI. The host may benefit from the vendor providing referrals to the host (e.g., real estate referrals). In some configurations, a vendor added to the vendor referral database (e.g., after being determined reliable by the host) will be sent an item of value and/or a credit toward services available through the host website, e.g. the item being sent by the host to encourage future interactions by the vendor with the host's website.

In addition, the host's website can include links that would be useful to a user. For example, these links could include links to: local school information, governmental agencies, local professional sports franchises, local tourist destinations, local geographical community websites (e.g., The Scripps Ranch Civic Association website), local charities, organizations representing the arts, or other community orientated websites. Moreover, the host's website can include articles aimed at educating the user as to how to choose a vendor and how to oversee work performed for a user by a vendor. These articles can be embedded in the website and/or available via hyperlinks to other websites.

As described previously, process 100 may be implemented as a dynamic process, e.g., supplementary vendor referral information may be received and added, or changes made, to the vendor referral database. Therefore, a host may obtain and/or expand business contacts included in its sphere of influence. In a configuration of system, supp./changed vendor referral information may be obtained proactively by the host, e.g., by contacting (e.g., soliciting) vendors via mail, e-mail, phone and/or fax communications.

System 10 and/or process 100 may be replicated two or more times allowing many different host entities to serve and/or control their own respective websites, e.g., to control the content and reliability of their vendor referral database. In that case, each host's website may use vendor referral information from its host's SOI. In some implementations, the URL of a host website is limited to a geographic area, such as within a specific zip code (or set of zip codes) or within a geographic area associated with a realty agency. In this case, a website having an associated geographic area allows the host to be assured of geographic independence from a competing host website. Although a website may be limited geographically (e.g., by a domain name or URL) to a host's defined area, (e.g., or by a name associated with a geographic area, such as “scrippsranch-a-list.com”) the vendors provided by the host's website may be located outside of the host's defined area. Thus the system can be franchised such that multiple, such as hundreds or thousands, of different host entities could exist.

In an embodiment with two or more different host entities, a first host website is controlled by a first host entity and a second host website is controlled by a second host entity. The first host website displays a first set of vendor referral information in a first vendor referral database. The first set of vendor referral information would correspond to a sphere of influence of the first host entity. The second host website displays a second set of vendor referral information in a second vendor referral database. The second set of vendor referral information would correspond to a second sphere of influence of the second host entity. In an embodiment, the first and second set of vendor referral information are different.

In an embodiment where system 10 and/or process 100 is replicated two or more times allowing many different host entities to serve and/or control their own respective websites, there may also be one master host website that can include hyperlinks to the different host websites. For example, a user using a master host website could choose from a selection of host websites in which to connect. In one embodiment, there are not hyperlinks that go both ways—the master host website provides hyperlinks to the different host websites but the different host-web sites do not include a hyperlink to the master host website. Alternatively, a user desiring services that a host website does not provide, such as services in another geographical area, or simply wanting to view other host websites, could be directed to other host websites and/or the master host website such that the user could select an alternative host website (such as via a drop down menu including selections for the various alternative host websties). Alternatively still, a user desiring services that a host website does not provide, such as services in another geographical area, or simply wanting to view other host websites, could inform the host of this desire (such as via email, clicking a button on the website, or by telephone) and the host could then refer the user to an alternative host website. If the host refers the user to an alternative host website and the referral results in the consummation of a real estate transaction with the host of the alternative website (e.g., buying or selling real estate), the alternative host-web site could be required to pay a referral fee to the host.

The master host can advertise its services and/or advertise for the host websites. In one embodiment, a portion of a monthly payment paid by each host to the master host can be used to finance an advertising fund that is used to market the hosts on either a national basis or in the locale of the individual hosts. Further, the master host can provide the different hosts with computer-related material used to create and/or maintain the different host websites (for example via electronic mail, overnight delivery, mail, fax, or the like), as described herein. Thus, it is not necessary for the master host to have a master host website. Additionally, there may be local master hosts (for example divided by state or county) under the master host, such that the local master hosts interact with and assist their respective hosts (e.g., hosts in the local host's geographical area). For example, the local host can provide advertising for all of its respective hosts. Further, each local host can have a website, wherein the local host's website is hyperlinked to its respective host websites and/or the master host website. In one embodiment, the local host (or master host) comprises a real estate company and the hosts under the local host (or master host) comprise real estate branch offices and/or agents working with the real estate company. Such hosts could be divided up by geographical area (such as by zip code).

In another embodiment, the host websites and/or local host websites use subdomains to the master host's domain name. Alternatively, the host websites use subdomains to the local host's domain name. For example, if the master host was at the URL “www.sandiegocounty-a-list.com,” a host for Scripps Ranch could use the subdomain “scrippsranch” with the URL “www.scrippsranch.sandiegocounty-a-list.com.”

In an embodiment, a large company (e.g., a real estate or insurance company) is given a geographically exclusive right and authority to implement a vendor referral system described herein, exclusive of other agents or companies (e.g., other real estate or insurance companies). Such exclusivity could increase the value of the system to the local host (e.g., market place uniqueness) and provide a tool that would help: recruit new agents to join the local host, retain existing agents of the local host, and deter existing agents of the local host from defecting to a competitor of the local host.

In various implementations computer-related material is provided (e.g., sent or available for downloading) to a host of a website. For example, to allow a new host to initiate and/or maintain a host website, the computer-related material is provided in one package that allows the new host to initiate its host website. To initiate the host website, the computer-related material can include a template website that can easily be populated with customizable information. For example, the host can select from various options to customize its information on the website, allowing each host website to be unique. The computer related material may include the following: the template website, software, explanatory material for the website, template-style marketing materials, sample vendor notification/solicitation letters and/or legal agreements (e.g., usable for vendor registration). Thus, the computer-related material sent to the hosts provides the hosts with a turnkey host website, such that the host website is easily initiated and/or maintained using the computer-related material.

In an implementation, a user's selection of an active area on the host website page causes vendor referral information to be displayed on a window of a user device. Alternatively, the active area corresponding to vendor referral information may be implemented as a hyperlink to another web-page document where the vendor referral information may be obtained and/or displayed. The host website may include information on how a user may submit a request to be added as a supplementary vendor referral.

A host website implemented in accordance with system 10 and/or process 100 may include applications that are usable by the host and/or a user to organize and utilize information related to the vendor referral information. For example, system 10 may include an application for creating mailings to vendors listed in the vendor referral database, or, to users of system 10. System 10 may also include an application for setting activity reminders and submitting information relating to a vendor and/or a user of system 10.

Acceptable supplementary vendor referral information may be added to the vendor referral database as a result of user or vendor action (e.g., by a user or vendor interacting with a browser screen and inputting data to reflect the supplementary vendor referral information) or by the host. Optionally, process 100 may confirm that a supplementary vendor referral is a non-redundant vendor referral before adding the supplementary vendor referral to the vendor referral database.

Process 100 optionally may include a vendor contact process that is performed prior to storing an initial vendor referral entry, or a supplemental vendor referral entry, in the vendor referral database. In more detail, once a host has entered a vendor, or has received supplementary vendor information, the vendor contact process may be performed to send a “package” of information to the supplementary vendor to explain the process 100 and to solicit the vendor's participation in the process. If the vendor agrees to participate in the process, the vendor may then respond to confirm entry of his/her vendor information in the vendor referral database. Once a vendor has agreed to participate as a vendor included in the vendor referral database, the host may send the vendor an item (or credit) of value to encourage the vendor's future interaction with the host's website and/or encourage submission of supp./changed vendor referral information, or the like. Moreover, by including the vendor in the vendor referral database, the vendor is more likely to refer business back to the host. Thus, a reciprocal relationship is entered into between the host and its vendors.

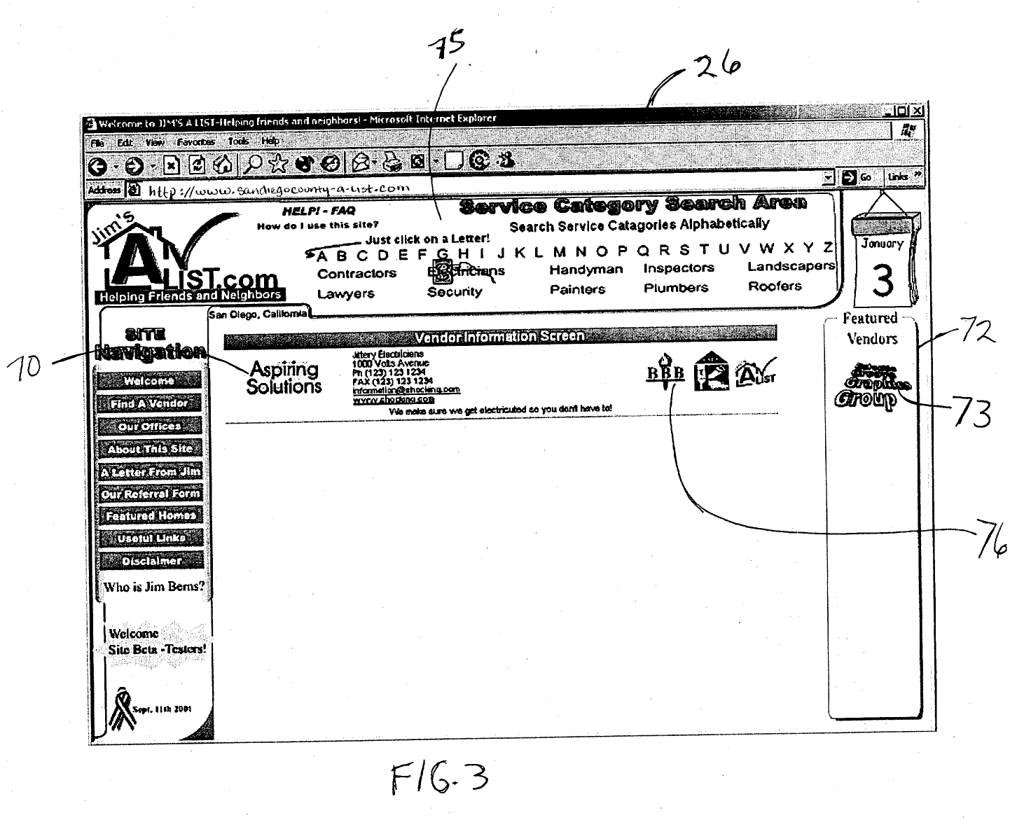

FIG. 3 depicts an exemplary host web-page 26 that includes vendor information areas 70, 72 and 75. In this example, vendor information area 70 includes a vendor referred from the host's SOI (e.g., a vendor from the host's initial SOI, or a supp./changed vendor that has been determined reliable). Vendor information area 72 includes a vendor logo 73 representing a featured vendor from the vendor referral database. Vendor information area 75 may include a directory of vendor referral information that, for example, is presented in an alphabetical format (e.g., selecting a letter in the alphabetical listing may cause an additional window to be displayed for the letter selected). Web-page 26 may also include an active area that links to business related websites, for example, a Better Business Bureau™ site 76, a government site related to home contractors, a consumer information site, and the like. Host web-page 26 may include additional images and/or active areas that relate to featured homes for sale, and/or service categories related to categories of vendors in the vendor referral database, and/or the like. The vendor display icon may also have related links, that provide information on how the vendor was referred to the host website, e.g., as an initial SOI vendor referral, or as a supplementary vendor referral, in which case the source of that supplementary vendor referral information may also be supplied. The host website may also present information representing feedback (e.g., comments, complaints, compliments) related to a vendor that was obtained from a referring party.

The host website may include an associated “dynamic directional commercial (window)” that presents additional information and/or an advertisement for a limited time period within a first browser window. “Dynamic directional commercial window” (DDCW) refers to a window of information associated with a vendor included in the vendor referral database for the host website. The DDCW is presented as a layer within a browser window, as opposed to a so-called “pop-up” window which causes the opening of a separate browser window in front of or behind a first browser window, forcing the user of the display device to close the pop-up window. A DDCW may open “automatically”, e.g., in response to a user's request for information related to a specific vendor from a host's vendor referral database. The DDCW may include-information to advertise the vendor selected, or a different vendor who was located within the same geographic region as the vendor chosen by the user. In an implementation, the DDCW is displayed for a limited time, e.g., in a range of 1-10 seconds, inclusive. Following the display during the limited time period, the DDCW closes, e.g., stops displaying the vendor referral information and/or advertisement information. The DDCW may present animations, e.g., scalable vector graphics, multimedia presentations, Flash™-based presentation, or the like.

Moreover, the host website may include dynamic screen door advertisements. A screen door advertisement is shown when a user selects a particular vendor or vendor category from the host's website. The screen door advertisement pops up, showing a multimedia presentation (or the like) to the user regarding the particular vendor. After displaying the screen door advertisement, the user could be transported to the vendor's website. The screen door advertisement may appear for vendors that pay a fee to the host, or for vendors otherwise selected by the host. The screen door advertisement may be unique, such that users that go directly to the vendor's website would not see the screen door advertisement, only users that go to the vendor's website through the host would see it.

The host website may be served from server computer 12, and accessible by a password given to the host. The password allows the host to interact with server computer 12 from a user device and control the display and information available through the host's website. The password access may allow a host access to a protected area of information that is personal to the host, and/or allows interaction with management tools/applications to further manage and control information stored in the vendor referral database.

The vendor referral database may also be stored on a separate database accessible to the host, and may also include additional information obtained through a user's and/or a vendor's interaction with the host website. For example, the additional information may include feedback from a user or vendor. The vendor referral database information may be used by the host to send messages to a vendor or user to solicit additional information, to communicate special events, send and/or receive vendor update information, announce vendor promotions, send a newsletter, or the like.

In an embodiment, the SOI database does not reside on the host's website. For example, the SOI database could utilize software such as Top Producer™, On-Line Agent™, Goldmine™, Outlook™ or the like, which stores its information separate and apart from the host's website.

In an embodiment, the vendor referral database does not reside on the host's website. For example, the vendor referral database could utilize software such as Top Producer™, On-Line Agent™, Goldmine™, Outlook™ or the like, which stores its information separate and apart from the host's website. In another embodiment, the vendor referral database is stored with the information on the host's website.

In one embodiment, vendors are organized into vendor categories. These vendor categories may include one or more of the following: Abatement, Air Duct Cleaning, Appliance Repair, Appliances, Appraiser, Alarm Systems, Architects, Artwork and Framing, Asbestos Removal, Attorney, Auctioneers, Automotive Services, Awnings Installation/Repair, Banking/Savings & Loan/Credit Union, Boats and Docks, Blinds, Bulkhead Inspectors, Cabinets & Woodworking, Cable Services, Car & Truck Rental, Carpentry, Carpet Cleaning, Carpet Installation, Carpet/Tile/Wood/Flooring, Catering, Cellular Phones/Service, Chefs/Cooks, Childcare Services, Chimney Inspection & Repair, Chimney Sweeping, Cleaning Services, Closet Organizer, Closing Attorney, Closing Gifts/Gifts Baskets, Community Services, Computer Networking Services, Computer Repair Services, Computer Training Services, Concrete/Stucco/Masonry, Contractor, Courier/Messenger Services, Cruises, Decorators, Decks and Patios, Demolition Service, Drainage Correction, Driveway Inspections & Repair, Driveway Paving, Dry Cleaning, Drywall Installation and Repair, Electricians, Environmental Clean Up, Escrow Services, Estate Sales, Excavating, Exterminator, Fencing Repair & Installation, Feng Shui, Financial Services/Advisors/CPAs, Fireplaces/Wood Stoves, Firewood, Fitness Trainers, Florist, Foundation Repair, Funeral Homes, Furniture Rental, Furniture Stores, Furniture/Upholstery Repair, Garage Doors, Gardening/Landscaping, Geological Inspection, Glass Specialist, Hair Salons, Handyman Services, Hardware/Building Supplies, Hardwood Flooring, Health Clubs, Heating & Air Conditioning, Home Heating Fuel, Home Inspection, Home Theater Electronics, Home Warranty, Horse Trainer, Horse Stables, Hotels/Inns & Motels, House Stager, House wares, Insulation Installation, Insurance Broker, Interior Decorating, Internet Service Provider, Interpreter, Investments & Retirement Planning, Keys Made, Kitchens & Baths, Landscaping & Gardening, Lawn Care, Lead Testing, Locksmith, Mailing Services, Mortgage Companies, Motor Vehicle Registration and Licensing, Moving Companies, Musical Instruments/Instruction, Notary Public, Office Equipment, Office Supplies, Painting, Pest Control, Pet Care/Sitting/Grooming, Pet Shop, Photographer, Photography Supplies, Piano Tuning, Plumbing, Pool & Spa Cleaning Service, Pool & Spa Construction, Power Equipment Rental, Power Washing, Printers, Property Management, Radon Gas Inspection, Radon Gas Mitigation, Rain Damage, Rain Gutters, Recreational Equipment Sales & Rentals, Remodeling, Restaurants, Retaining Wall Construction/Repair, Roofing/Roof Repair, Satellite Services, Security Systems, Self-Storage, Septic/Sewer, Sewing/Alterations, Siding Installation/Repair, Signs/Graphics, Snow Removal, Structural Engineer, Surface Refinishing, Surveyor, Swimming Pool Services, Tax Preparation, Telephone Services, Temporary Housing, Termite Inspection, Title Companies, Trash Clean Up & Hauling, Travel Agencies, Travel Services, Tree Spraying, Tree Trimmer, Upholstery Cleaning or Repair, Veterinarian, Wall Paper Hanging, Water & Septic Inspection, Water Damage/Flooding Clean Up, Water Delivery Service, Water Proofing, Water Treatment, Web Page Designers, Well Digging, Window & Door Installation, Window & Screen Repair, Window Treatments, Window Washing, or the like. Thus, the vendor categories can be related to or not-related to the profession of the host.

Optionally, a host website may include advertising images. The advertisement images may be related to vendors included in the vendor referral database, and/or a business entity associated with the host. Advertising images may be limited to those approved by the host and/or referred by a previously stored vendor in the vendor referral database.

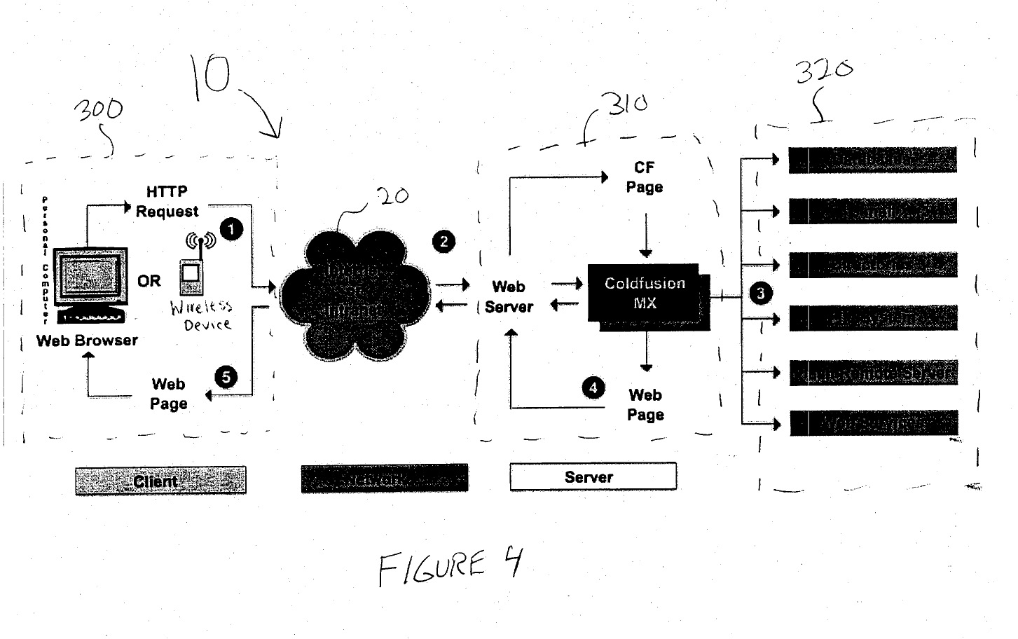

Referring to FIG. 4, in an implementation of system 10, a server system 310 serves data to a user system 300 through Internet/intranet 20. Server system 310 includes a Macromedia software product (e.g., “Coldfusion MX”) that processes user requests for vendor referral information, commands and request from a host of a website, or the like. Server system 310 includes a data link 320 that may be used to send and/or receive data, e-mails, files, web documents, or the like to a user of system 10 or a host who controls and manages system 10.

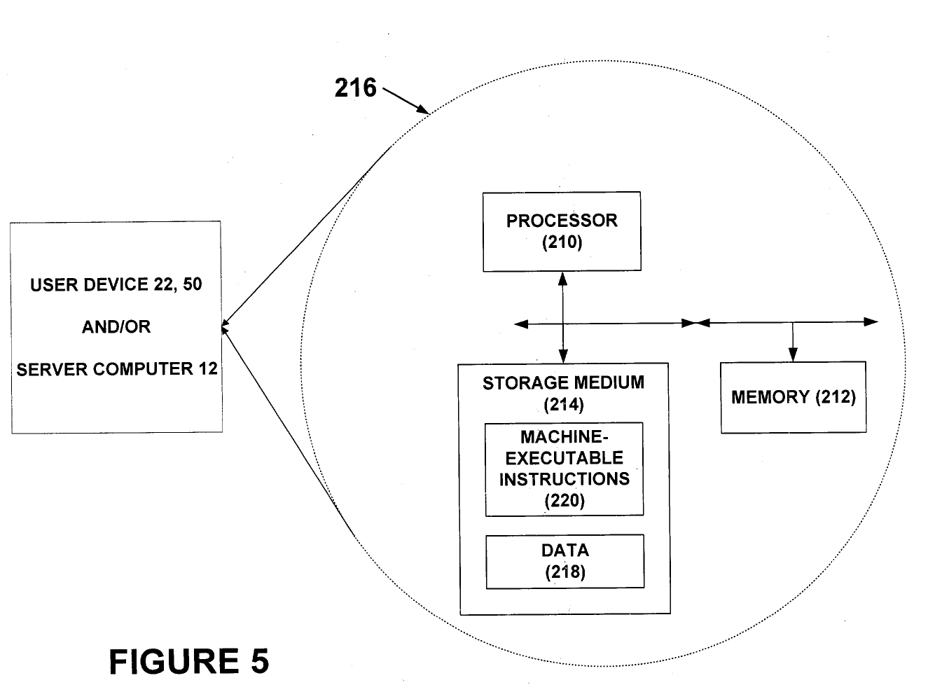

Referring to FIG. 5, in an implementation of system 10, user devices 22, and 50, and/or server computer 12 may include a processor 210, a memory 212, and a storage medium 214 (see view 216). Storage medium 214 stores data 218 for description documents and also stores machine-executable instructions 220 that are executed by processor 210 out of memory 212 to perform user device functions (for example, display/browser application 25), and/or server computer functions (for example, server process 100). Furthermore, each user device and host computer may include an operating system.

User devices and/or host computer are not limited to use with the hardware and software of FIG. 5. It may find applicability in any computing or processing environment. They may be implemented in hardware, software, or a combination of the two. They may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform applications and to generate output information.

Each computer program may be stored on a storage medium/article (e.g., CD-ROM, hard disk, or magnetic diskette) that is readable by a general or special purpose programmable computer for configuring and operating the computer when the storage medium or device is read by the computer to perform applications. They may also be implemented as a machine-readable storage medium, configured with a computer program, where, upon execution, instructions in the computer program cause a machine to operate in accordance with those applications.

The system and/or processes described herein, or certain aspects or portions thereof, may take the form of program code (e.g., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the system and/or processes described herein. The system and/or processes described herein may also be embodied in the form of program code that is transmitted over some transmission medium, such as over electrical wiring or cabling, through fiber optics, or via any other form of transmission, wherein, when the program code is received and loaded into and executed by a machine, such as a computer, the machine becomes an apparatus for practicing the system and/or processes described herein. When implemented on a general-purpose processor, the program code combines with the processor to provide a unique apparatus that operates analogously to specific logic circuits.

The invention is not limited to the specific embodiments described above. For example, the above has described the host of a website being a real estate professional. However, another type of business professional, or a business entity, could implement a system and/or process as described above to obtain and present and/or expand a vendor referral database. The processes depicted in flow charts and methods herein may be performed in a different order than as depicted and/or stated.

Other embodiments not described herein are also within the scope of the following claims.

What is claimed is:

1. A method comprising:
storing a set of vendor referral information in a vendor referral database, wherein the set of vendor referral information corresponds to a sphere of influence of a host entity, and wherein the host entity controls the storing of the vendor referral information stored in the vendor referral database;
receiving a vendor referral inquiry on a computer network; and
sending at least one vendor referral from the vendor referral database in response to the received vendor referral inquiry.

2. The method of claim 1, further comprising:
receiving supplementary vendor referral information;
determining that the supplementary vendor referral information satisfies a threshold of reliability; and
adding the supplementary vendor referral information to the vendor referral database.

3. The method of claim 2, wherein determining further comprises:
determining the supplementary vendor referral information was sent by an entity included in the set of vendor referral information.

4. The method of claim 3, wherein determining that the received supplementary vendor information exceeds a threshold of reliability further comprises:
setting the threshold of reliability by the host.

5. The method of claim 2, wherein sending further comprises:
sending information displayable on a user device, the information related to a business entity.

6. The method of claim 2, wherein the supplementary vendor referral information comprises a non-redundant set of information stored on a computer coupled to the computer network.

7. The method of claim 2, wherein receiving supplementary vendor information comprises receiving supplementary vendor information corresponding to a user interaction with a browser window.

8. The method of claim 2, wherein receiving further comprises:
receiving the vendor referral query on the computer network from a user device.

9. The method of claim 2, further comprises:
displaying the vendor referral information on a display window of a user device.

10. The method of claim 9, further comprises:
displaying the vendor referral information on a browser window of the user device.

11. The method of claim 10, further comprises:
displaying an additional window over the vendor referral icon on the display window of a user device, the vendor referral icon being associated with an active area.

12. The method of claim 10, further comprising:
detecting a selection of the active region; and
sending data representing an additional image displayable on a browser window, the additional image including an image associated with vendor referral information.

13. The method of claim 12, wherein sending data representing an additional image displayable for a limited time period.

14. The method of claim 13, wherein the additional image comprises an advertising image.

15. The method of claim 14, wherein the advertising image corresponds to a vendor from the vendor referral database.

16. The method of claim 2, further comprises:
soliciting additional vendor referral information from a one of a plurality of vendors included in the vendor referral database.

17. The method of claim 1, wherein the host entity comprises a real estate professional.

18. The method of claim 1 further comprising displaying a screen door advertisement relating to the vendor referral.

19. The method of claim 1 wherein the reliability level of the vendor referral is indicated.

20. A computer-implemented method comprising:
maintaining a repository of vendor referral information comprising vendor referral information and corresponding to a sphere of influence of a host entity;
receiving a vendor referral inquiry on a computer network; and
in response to the received vendor referral inquiry sending at least one vendor referral from the repository of vendor referral information.

21. The method of claim 20, further comprising:
receiving supplementary vendor referral information;
determining that the supplementary vendor referral information satisfies a threshold of reliability; and
adding the supplementary vendor referral information to the repository of referral information.

22. The method of claim 21, wherein determining further comprises:
determining the supplementary vendor referral information was sent by an entity included in the repository of referral information.

23. The method of claim 21, wherein determining that the received supplementary vendor information exceeds a threshold of reliability further comprises:
indicating the threshold of reliability by the host entity.

24. An article comprising a storage medium having stored thereon instructions that when executed by a machine causes the machine to perform the following:
maintain a repository of vendor referral information comprising vendor referral information and corresponding to a sphere of influence of a host entity;
receive a vendor referral inquiry on a computer network; and
in response to the received vendor referral inquiry send at least one vendor referral information from the repository of vendor referral information.

25. The article of claim 24, further comprising instructions that when executed by a machine cause the machine to perform the following:
receive supplementary vendor referral information;
determine that the supplementary vendor referral information satisfies a threshold of reliability; and
add the supplementary vendor referral information to repository of referral information.

26. The article of claim 25, further comprising instructions that when executed by a machine cause the machine to perform the following:
determine the supplementary vendor referral information was sent by an entity included in the repository of referral information.

27. The article of claim 26, wherein determining further comprising instructions that when executed by a machine cause the machine to perform the following:
set the threshold of reliability by the host entity.

28. The article of claim 24 wherein in response to the received vendor referral inquiry a screen door advertisement relating to the vendor referral is displayed.

29. A method comprising:
sending computer-related material to first host, wherein the first host controls a first host website, the first host-web site being initiated using the computer-related material, wherein the first host website displays a first set of vendor referral information from a first vendor referral database, the first set of vendor referral information corresponding to a sphere of influence of the first host entity; and
sending said computer-related material to second host, wherein the second host controls a second host website, the second host-web site being initiated using the computer-related material, wherein the second host website displays a second set of vendor referral information from a second vendor referral database, the second set of vendor referral information corresponding to a second sphere of influence of the second host entity.

30. The method of claim 29 further comprising a master host website, wherein said master host website is hyperlinked to said first host website and said second host website.

31. The method of claim 30 further comprising a local master host website that is hyperlinked to said first host website.

32. The method of claim 29 wherein said first and second host websites-are turnkey websites.

33. A system comprising:
a server computer;
a storage device coupled to the server computer, the storage device having a set of vendor referral information stored thereon, the set of vendor referral information corresponding to vendors within a sphere of influence of a host,
the server computer having a network interface coupled to receive a vendor inquiry and send at least one vendor referral in response to the received vendor inquiry, and receive supplementary vendor referral information.

34. The system of claim 33, wherein the vendor referral information stored on the storage device comprises a non-redundant set of data.

35. The system of claim 33, wherein the host controls access to the storage device, and wherein the host determines additional information that may be added to the storage device.
